(19) United States
(12) Patent Application Publication
(10) Pub. No.: US 2024/0124811 A1
(43) Pub. Date: Apr. 18, 2024

(54) INGREDIENTS AND METHOD FOR THE PREPARATION OF AUTEUR DRINKS

(71) Applicant: TECNOBLEND S.R.L., Altamura (BA) (IT)

(72) Inventors: Gianluca Fraccascia, Gioia del Colle (BA) (IT); Francesco Nicoletti, Altamura (BA) (IT)

(21) Appl. No.: 18/276,793

(22) PCT Filed: Feb. 11, 2022
(86) PCT No.: PCT/IB2022/051242

§ 371 Date: Aug. 10, 2023

(30) Foreign Application Priority Data
Feb. 17, 2021 (IT) 102021000003635

(51) Int. Cl. C12G 3/06; A23L 27/12; A47J 43/27; B65D 1/02; B65D 41/02; B65D 51/24; C13B 50/00

(52) U.S. Cl. CPC C12G 3/06; A23L 27/13; A47J 43/27; B65D 1/02; B65D 41/02; B65D 51/24; C13B 50/00

(57) ABSTRACT

The present invention is mainly applied in the context of the production of original beverages even in premises such as bars or kiosks that have authorizations just for food dispensing, because they are typically not equipped with a kitchen that complies with certain requirements set by the standard for making certain food preparations. The foods distributed in such premises, foods or drinks that are, therefore, must be prepared, in their main ingredients, elsewhere: being possible to practice on-site only the final stages of preparation, generally very simple, and substantially limited to mixing operations of ingredients with mechanical actions (shaking, mixing, squeezing, etc.). A distinctive product for many of these places are the drinks prepared by the barmen, who make real “auteur drinks”, for example absolutely original cocktails, as characterized by a decisive expressive originality of the barman's creativity.

### BACKGROUND OF THE INVENTION

### 1. Field of the Invention

The present invention is applied in the context of food preparations in environments which are equipped and authorized just for the distribution of food.

In particular, the invention proposes a solution for preparing original drinks even in places such as bars or kiosks which, when not equipped with a kitchen that complies with certain requirements of the standard, have authorizations just for food dispensing. The foods distributed in such premises therefore (either foods or drinks) must be prepared, in their main ingredients, elsewhere: being possible to practice on-site only the final stages of preparation, generally very simple, and substantially limited to ingredients' mixing with mechanical actions (shaking, mixing, squeezing, etc.).

A distinctive product for many of these places are the drinks prepared by the barmen, who make real “signature drinks” (in the following, also referred to as “auteur drink”). Therefore, in the following, with the term “auteur drink” we will refer to drinks made with original recipes and preparation methods, developed by a barman. Typically, these drinks are cocktails, but they can also be another type of drink such as, for example, long drinks or aperitifs.

### 2. Brief Description of the Prior Art

The typical preparation method of these “auteur drinks” involves mixing a certain number of ingredients. The originality that can be obtained is limited to the adjustment of the dosages of the ingredients themselves, and to the use of particular mechanical preparation and mixing techniques.

These mechanical preparation and mixing techniques can in fact be very varied, and make use of particular tools: for example, special containers, called “shakers”, inside which the ingredients are “shaken” (as said in the bartenders' jargon), or special shaped ladles, whips, up to the use of mechanical blenders or centrifugal machines, etc.

Although the variety of “auteur drinks” that can be made is already very wide, some particularly creative bartenders feel the need to prepare, by themselves, some ingredients not available on the market, to introduce more and more particular aromas. The preparation of these ingredients often involves infusion or maceration techniques, sometimes even forms of cooking for the hot extraction of particular aromas, and other preparations that cannot be considered a pure mechanical treatment of the original ingredients.

If these preparations are used, which involve treatments that are not limited to a pure mechanical treatment of the original ingredients, in Italy, as well as in many other countries in the world, it is necessary to have an environment that complies with adequate hygiene standards required by law. In short, an environment with the characteristics of a kitchen is needed, while in a large number of places where such drinks are served, there is no kitchen, or an environment with the required characteristics.

Furthermore, preparations such as those conceived by the most creative barmen, often require a lot of time, and must be made in sufficient quantities to meet a need that is not always predictable at the time of preparation itself. Even the preparation of excessive quantities of a certain ingredient, to meet potentially numerous requests, on the other hand, should be avoided: this is due to the perishable nature of certain ingredients, or simply for cost reasons.

Ultimately, there are objective and technical limitations to the creative freedom of barmen, in the creation of their “auteur drinks”, and these limitations are a real reason for discomfort, because they concern a type of offer that has the connotation of high craftsmanship, in which the authors (i.e., the barmen) perceive themselves in some ways as artists, who feel the need to give shape to their creative inspirations. In many real cases it occurs that some preparations are put into practice in violation of hygiene rules; and this, in addition to entailing the risk of incurring in penalties, also constitutes a health risk.

A solution to improve this uncomfortable situation, suitable to better satisfy the creativity of the barmen, can only take the path of offering a more versatile quantity of ingredients than those available today.

Please note that, for the reasons set out above, the ingredients to be made available to the barmen must all be designed to be mechanically mixed and treated (by shaking, mixing, squeezing, etc.); the personalization of the taste can only be obtained by adjusting the dosages and mixing techniques.

The ingredients currently offered by the known art consist essentially of other ready-made drinks, which can theoretically also be consumed neat, such as liqueurs, soft drinks, fruit juices or squeezed juices, and flavored syrups with various aromas; the latter, obviously, cannot be taken neat, but they are used a lot to give the drink, which is going to be prepared, a particular taste.

The use of syrups, in particular, is widespread as it allows you to combine very particular flavors simply by diluting a small amount (it is an ingredient with a very concentrated flavor) in the drink being prepared. However, although the syrups available on the market are numerous and present a wide variety of aromas, they are still perceived as a very limiting ingredient in the creation of an “auteur drink”, such as a cocktail. In fact, it is a widespread perception among mixologist bartenders to consider commercially available syrups as a factor of rigidity in the preparation of their drinks.

In order to briefly illustrate the nature of these limitations, we summarize below how a cocktail is made up. Each cocktail has its own recipe whose composition is divided into: alcoholic part, sugary part, flavoring part, acid part and (but only for some types of cocktails) gaseous part.

At the moment, the market offers products that combine the sugary part and the flavoring part, these products are the so-called “syrups”, which, as mentioned, are products ready to be used for dilution in cocktails. Each syrup has its own taste/aroma and leaves no room for any kind of personalization by the barman.

Therefore, such ingredient, consisting of the flavored syrup, is on the one hand a very important ingredient, because it allows the barman to give particular aromas to the drink he is preparing, on the other hand it represents an ingredient that is too binding, as it binds the sugary and the aromatic parts too stiffly.

Moreover, the known technique does not offer alternatives for the management of more particular aromas, and consequently the barmen are, in fact, forced to resort to pre-established syrups: the alternative being to resort to the production of homemade syrups, with all the contraindications briefly summarized above.

As already mentioned, however, and despite the contraindications, it is usual that in the environment of the most advanced bartenders all kinds of homemade syrups are prepared, macerating or infusing various types of spices or berries, then combined with sugar syrup, always prepared by hand, accepting all the involved risks. In fact, this whole process takes a long time and it is not always possible to establish a real expiration date, encountering problems related to the quality of the product and health regulations, as well as the risks of sanctions, if you are not in compliance to carry out this kind of preparations.

The facts show that the law is not always sufficient to discourage the creative spirit of the most advanced barmen, and the tendency not to use ready-made flavoring syrups, such as those currently available on the market, is significantly widespread. It is therefore not so difficult to find places where it is possible to taste cocktails made with syrups personally made by the barmen who prepare them being able to give them a personal character. In fact, the need to differentiate themselves from the competition and offer customers, increasingly demanding, a unique sensory experience is increasingly urgent, also playing on the fact, perceived as an added value, of offering an artisanal product.

In this regard, it is noted that home-made syrups, although they actually have hygienic-sanitary contraindications, compared to classic industrial syrups, are nevertheless perceived as more “natural” products, and therefore, on an emotional level, they are more appreciated by part of the customers.

It is known, in fact, how it is easier to convey messages regarding characteristics of naturalness on handcrafted products, or on simple products, thus playing on the impression of making drinks directly from raw materials, and not when using semi-prepared ingredients, already sophisticated from the start.

It is clear that all these aspects of communication concern the emotional management of a product, and are not, as such, technical aspects; however, although these are aspects concerning communication techniques, they are also aspects strictly dependent on the objective and physical characteristics of the ingredients: in fact, it is much easier to associate a message of naturalness with an ingredient, the more it is similar to a row material, for example when it is an ingredient directly obtained from a substance as it occurs in nature, or when it is obtained with extreme simplicity or with techniques that belong to tradition.

Therefore, it is certainly easier to associate an attribute of naturalness to an artisanal syrup, homemade from ingredients perceived as raw materials, compared to an already flavored and industrially packaged syrup.

Ultimately, it can be said that the known art does not seem to address the problem of making syrups in an innovative way, to meet market demands and to offer customizable flavors, in order to satisfy the needs of barmen who want to make cocktails or, in general, “auteur drinks”, more and more original.

Furthermore, the trend in the sector is looking for beverages for which it is easy to convey a message of naturalness and craftsmanship, and which are potentially unique creations: at the limit of being unique for any single preparation.

The known technique proposes innovative procedures for preparing cocktails, such as in CN 108823049-A [“Cocktail preparing method and cocktail”, Cui, Jie et al.—Nov. 16, 2018], where a particular method of making cocktails is taught, extracting aromas in an innovative way. It is a method that can be implemented by hand, but it certainly requires a long work and laboratory equipment. CN 108823049-A certainly does not provide information on making a cocktail on the spot, perhaps in front of the customer, so much so that one of the advantages of the preparation is that it can be prepared in advance, and then served on request, almost as if it were a finished drink.

Other interesting solutions on the subject teach how to make syrups of better quality than the existing ones.

For example, in U.S. Ser. No. 10/111,445-B1 [“Procedure for preparing premium cocktail berries”, Foss, Natalie Denise et al.—Oct. 30, 2018] it is taught how to prepare a syrup that can be flavored with blueberries (but the process can potentially be implemented with different types of berries), in a way that optimally preserves the flavor and texture of the natural fruit. Also in this case, it is a product that, although it can be used for the creation of particular and special cocktails, it does not lend itself to satisfying the need for personalization of taste so felt by many bartenders. In fact, the procedure taught in U.S. Ser. No. 10/111,445-B1 is applicable only with a specific type of flavorings (i.e., aromas derived from berry fruits) and the preparation of the syrup is certainly a long and relatively cumbersome process, it is a preparation to be carried out in advance, and it has not freedom in the dosages, as the goal is to preserve the appearance, the consistency and the taste of the fresh fruit for a long time, so that the recipe must be carried out with a fairly rigid precision.

### SUMMARY OF THE INVENTION

The general purpose of the present invention, therefore, is to indicate a set of different ingredients suitable for putting into practice a new method of preparing cocktails, or more generally “auteur drinks”, with a high degree of customization in the creation of the taste of the drink to offer to the customer.

In particular, the ingredients indicated in the present invention must be able to be treated exclusively by mechanical processing, such as mixing, shaking or squeezing, and the adjustment of the sweet and aromatic components to be given to the “auteur drink” must be suited to be conducted with absolute flexibility by the person who prepares the “auteur drink” itself, or rather by the barman.

Another important purpose of the invention concerns the characteristics of the ingredients indicated; these must have an expiration time that can be determined with absolute safety and must be packaged in such a way as to indicate the conservation instructions, which allows a relatively long duration before their deterioration.

At the same time, they must not be ingredients that lend themselves to chemical sophistication, as they are intended for the preparation of a drink about which it is vital to communicate a message that affirms its genuineness and the fact that it is a natural product.

Therefore, they must be ingredients which can be traced back to very clear and well-known types, for which it is easy and credible to associate a message that characterizes and promotes them as “natural products”.

The invention must therefore combine a set of prerogatives apparently difficult to reconcile:
it must indicate ingredients that can be produced with industrial logic, so as to be able to have maximum control of the processes that impact on the health and hygiene aspects; but, at the same time, it must indicate ingredients that actually allow the preparation of unique, personalized or customizable drinks, perceivable as handcraft drinks;
the ingredients must be as simple as possible, in the sense that they must be offered in such a way that they appear, as much as possible, as “natural” raw materials, suitable for being then handcrafted by the barman; moreover, they must be able to be treated and mixed with mechanical operations only, without placing excessive limitations on the creativity of the barman in controlling taste.

The aims set for this invention are achieved by resorting to a method for the preparation of “auteur drinks”, suitable for preparing a plurality of drinks with different flavors, and said method provides:
to use a single type of “basic syrup”, which includes water and extracts of one or more sweetening plants among its ingredients, being these first ingredients present in a preponderant quantity overall greater than 90%, while, in smaller quantities, there is a juice of one or more fruits that give acidity and small quantities of preservatives (limited, the latter, to 0.3%);
said “base syrup”, in each preparation, is suitable for being flavored, by diluting at least one essence inside it, extracted from natural ingredients, and said “basic syrup”, after it has been flavored as indicated in the previous point, it is diluted in other ingredients, according to any of the recipes for the preparation of beverages that use syrups.

The main advantage of the present invention consists in the fact that it teaches to apply a process that satisfies all the main objectives for which the invention itself was conceived.

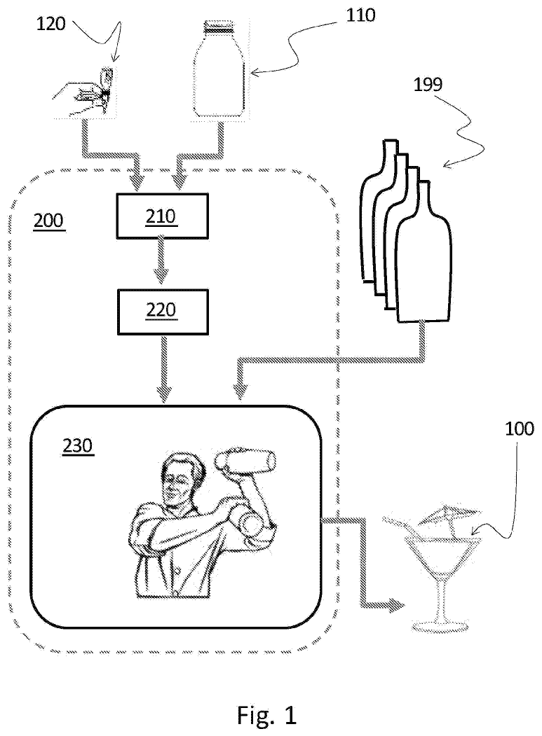

This invention also has further advantages, which will become more evident from the following description, which illustrates further details of the invention through some forms of implementation, from the attached claims, which form an integral part of the present description, and from the attached FIG. 1, in which there is represented simplified block diagram of the procedure for preparing a cocktail according to the invention.

### BRIEF DESCRIPTION OF THE DRAWINGS

In FIG. 1, the procedure for preparing an “auteur drink” according to the teachings of the invention is schematized, which allows you to summarize the salient aspects of the same.

The number 100 indicates the “auteur drink” ready to be served to a customer, while the numbers 110, 120 and 199 indicate the ingredients available to the barman. Finally, the number 200 indicates the complete preparation process that, starting with ingredients 110, 120 and 199, leads to the production of the “auteur drink” 100. The ingredient indicated with the number 110 is the so-called “basic syrup” described above and, in a preferred embodiment of the present invention, it is supplied to the barman in a bottle that can be directly used as a “shaker”.

### DETAILED DESCRIPTION OF THE PREFERRED EMBODIMENTS OF THE INVENTION

At the basis of the invention, there is the intuition to use a type of ingredient not frequently used, directly, in the preparation of “auteur drinks”, that is, the use of natural aromatic essences.

The so-called natural essences are ingredients that are part of the tradition.

The techniques for extracting essences from a vast variety of natural aromatic substances are many, and have their roots in the past; these are also very different techniques, which can exploit principles of maceration, distillation, infusion, or other techniques, and which allow to concentrate in very small quantities of product the greatest possible quantity of the molecules which generate the aroma that is intended to extract.

What these essences have in common, as the name implies, is the fact that they are flavoring substances that contain only what is essential to capture an aroma. In general, the fact that they are substances in which the presence of the fluids, in which the aromatic principles are dissolved, is reduced to a minimum, makes these substances generally not very perishable and with very stable characteristics, so that since ancient times, extraction techniques for such essences have been sought. Today there are essences of a large number of aromas, in turn extracted with a notable variety of well-known and consolidated techniques; these essences are widely used in various contexts, including gastronomic contexts.

Although these natural essences are well known, and their use in food contexts is also well known, they present some management difficulties for their direct use in the preparation of dishes or drinks. In fact, they are ingredients with extremely specific flavors, characterized and very intense, which require a very accurate dosage, to be performed, in many cases, with the dropper. Therefore, natural essences (as well as synthetic ones) are typically used industrially or in gastronomic laboratories, to flavor considerable quantities of some ingredients (for example flours or baked doughs): they do not lend themselves to being used to flavor individual portions of a dish or a drink. In fact, in the case of very intense essences, a single drop of essence could aromatize a sufficient quantity of an ingredient for dozens of portions. For this reason, despite the enormous potential, in terms of aromas, that could be exploited through the use of these essences, normally, it isn't so frequent to see bottles of essences in the counters where the bartenders are at work, since their direct use is too much complex and risky.

The other fundamental intuition, which is the basis of the invention, is in having conceived an intermediate ingredient which consists of a particular type of syrup, called “basic syrup”, which acts as a universal base that can be used to create a wide variety of syrups.

Said “basic syrup”, however, has some characteristics that distinguish it from the known syrups, and that make it particularly suitable for use in the implementation of the present invention.
a) A first characteristic is given by the fact that, in terms of flavor, it simply contains sweet notes: it does not introduce any particular aroma; this is very important because it leaves room for the creativity of the barman in choosing the specific aromas to use in the preparation of drinks.
b) A second peculiar characteristic consists in the fact that said “basic syrup” lends itself to being effectively described as a “natural product”, being in fact achievable in simple and natural ways; in fact, the best way for a message to pass through, and be credible, is for it to correspond to reality.
c) A third peculiar feature consists in the fact that said “basic syrup” is an ingredient that must act as a vehicle to manage the aromas of natural essences in an optimal way.

With reference to the first essential characteristic of the “basic syrup” made according to the teachings of the present invention, it is observed that the component of a sugary flavor (which at the end of the drink preparation can also be almost imperceptible, being combined with other dominant flavors) is in fact essential in the development of the “auteur drinks”, of which the present invention deals.

In fact, without the sugary component each drink is overall “flat” (according to the jargon of the barmen), that is, it does not involve and solicit some sensory parts of the taste, generating a sense of general incompleteness: in fact, it is practically impossible to create an “auteur drink” managing and balancing an eventual absence of the sugary part, which, therefore, is basically always present in every drink.

So, in summary, said “basic syrup” performs the first important function of conferring the sugar contribution to the drink, and brings it without being combined, a priori, with another aroma, as occurs instead when using normal syrups according to the known technique.

With reference to the second essential characteristic of the “basic syrup” made according to the teachings of the present invention, it is noted that it is possible to obtain sweetening substances by combining water and sugary plant extracts; some are valuable and have very appreciated properties, such as juice of agave. The latter, used together with cane sugar, gives rise to a well-balanced recipe for making a “basic syrup” according to the invention.

Furthermore, with the simple addition of lemon juice, a slight acidity is also given to the “basic syrup”, the presence of which is also necessary (as for the sweet notes) to obtain a “full” flavor, which is not “flat”.

Consistent with the purposes of the invention, which provide that the “basic syrup” does not introduce particular tastes other than the sweet taste, however, the addition of lemon juice must not be such as to highlight the flavor of the fruit, and the used quantity must be limited to what is strictly necessary for regulating acidity. In quantitative terms, the addition of lemon juice (or other fruits with similar characteristics) must generally not exceed 10%.

These fundamental ingredients in the composition of the “basic syrup” also have the property of conferring stability to it. In fact, acidity and sugar content provide an important parameter to avoid the development of pathogenic microorganisms, thus reducing the need to resort to other preservative substances, which can therefore be used in absolutely modest quantities, in general never exceeding 0.3%.

In some variants, the lemon juice can be replaced by a different juice, of one or more fruits that give acidity, however the choice of lemon juice is an excellent choice, for its easy availability and for its more neutral flavor than the taste, for example, of other citrus fruits; thus, leaving the barman more freedom in creating the overall taste of his “auteur drink”.

It is clear that such a simple ingredient can be successfully presented as an absolutely natural ingredient, and with absolute credibility. Even the possible presence, in very modest quantities, of other preservative substances such as malic acid, or other preservatives, therefore does not compromise the image of naturalness that can be conveyed with this ingredient.

Finally, the third peculiar characteristic of the “basic syrup”, made according to the teachings of the present invention, consists in the fact that it is an excellent vehicle for combining aromas of your choice through the use of appropriate natural aromatic essences: with reference to this important third feature, we need to go into it a little more.

In fact, it is observed that the essential aromas are not suitable to be used in purity, and this is the main reason why, in the context of the known art, they are supplied already integrated within specific flavored syrups, delegating to the syrup manufacturer the burden to proceed with the aromatization of the same.

In fact, it has been seen that the creation of an artisanal syrup is possible but it is a long process, and just a part of barmen, who are willing to bear the burdens and risks associated with this preparation, is willing to face it.

As will also be clarified in the following, the availability of a “basic syrup”, such as the one indicated in the present invention, allows the pure aromatic essences to make their appearance also in the counters of barmen.

Said “basic syrup” must therefore perform many functions, also of a technical nature, to allow the barmen who use it to have maximum control in defining the taste.

Among the prerogatives of greatest interest regarding the “basic syrup” according to the invention, its fluidity is certainly of significant importance, since once an “auteur drink” is ready to be consumed, it must be, more or less, as fluid as water: it may possibly be a little less fluid than water, but it certainly mustn't be viscous. In the practical preparation of an “auteur drink”, therefore, the syrup ingredient, which is generally a fairly viscous fluid, must be mixed in modest quantities with the other more fluid ingredients: this if you want to obtain fast and homogeneous mixes. Since the teachings of the present invention provide for the use of natural essences with a high degree of purity, and since these, due to their intrinsic characteristics, must be used in minimal quantities, it is very convenient for these essences to be diluted twice.

The first time, they are diluted when they are introduced in the “basic syrup”, a second dilution then takes place in the “auteur drink”, when the already flavored syrup is, in its turn, diluted in the other ingredients.

The first dilution of the natural aromatic essence in the “basic syrup” is one of the most distinctive aspects of the present invention. It achieves the main purpose of the invention, that is to allow a great deal of flexibility in the search for flavors, but it is an operation whose execution requires the resolution of some technical problems. A first technical problem consists in the control of the dosages. The mixing of the essence takes place on a special container of known capacity, and capable of containing a sufficient quantity of “basic syrup” for the preparation of a plurality of portions of drink. In this way, working on quantities greater than those for a single portion it is certainly easier to exercise an accurate control of the proportion of essence: remember that the quantity of essence to be used can be counted in a few drops (in the case of more concentrated essences) or in a few centiliters, while the quantity of “basic syrup” is measured in several deciliters.

Furthermore, the capacity and shape of the container where the mixing takes place must be suitable to facilitate mixing maneuvers. In a preferred embodiment, this container is the same bottle with which the “basic syrup” is supplied to the barman by the manufacturer, it is equipped with an airtight cap, and has a significantly greater capacity than the contained “basic syrup”. It is therefore suitable for supporting an effective shaking maneuver after the desired quantity of aromatic essence has been introduced into it, at the discretion of the barman.

A second technical problem is the need to control the fluidity of the “basic syrup”.

In fact, it is essential that the mixing of the aromatic essence takes place with perfect homogeneity; mixing by shaking is very effective for this purpose, however it only works perfectly if the fluid being shacked is not too viscous.

Well, the viscosity of the fluid to be mixed homogeneously, in fact, is given by the viscosity of the “basic syrup” (since the small quantity of essence is not sufficient to significantly vary the viscosity of the compound fluid). The experience and accurate tests with numerous test essences, have been able to ascertain that an optimal “basic syrup” has a viscosity of about 400 cP (centipoise) and a consistency, measurable with a Bostwick consistometer (instrument commonly used in the field food, such as to constitute a standard for consistency measurements), which shows a scroll of about 17/18 cm in 30 seconds, at room temperature.

Since the viscosity coefficient of the “basic syrup” is in turn determined mainly by the quantity of extracts from sugary plants, it is therefore necessary to appropriately calibrate the proportions between the quantity of water and the sugar component, so that the good fluidity required for the “basic syrup” does not go to the detriment of the sugar component, which must remain sufficient.

A favorite recipe for making a “basic syrup” according to the invention with all these characteristics of viscosity and sugary component is a “basic syrup” obtained with the use of agave juice.

Agave juice is a pure substance, quite valuable, which is obtained by direct extraction from the agave plant and has a very dense consistency similar to that of honey, for which it is frequently also called agave syrup. Through laboratory tests, it was possible to ascertain that concentrations of 65 brix, using agave juice (or other substances with similar characteristics of sweetness and density) and cane sugar, are an optimal concentration for the preparation of the “basic syrup”.

In general, a value for maximum viscosity of the “basic syrup” can be indicated, it must be less than 450 s cP. Remaining within the limit of this viscosity, it is possible to create a “basic syrup”, without watering down the product excessively, with a concentration of the sugar component around 65 brix (the final “auteur drink”, depending on the taste and consistency you want to obtain, can then be diluted with more or less aqueous ingredients), and in any case higher than 63 brix, which can be set as the minimum concentration parameter for this ingredient.

Laboratory tests have shown that this “basic syrup”, characterized by the parameters indicated above, has an optimal behavior both when it must act as a diluent for the natural aromatic essence, and when it must be diluted in the “auteur drink” in its complex”.

This double function of the “basic syrup” is distinctive with respect to the normal syrups according to the known art, which must not be used to dilute other substances inside them, but must only be diluted inside the final beverage which has to be prepared, being poured in smaller amount in a more abundant and more fluid liquid; while the “basic syrup” according to the invention must also act as a diluting substance for aromatic essences, and only after this flavoring phase, it must, in its turn, be diluted in the beverage being prepared.

This succession of dilutions is in fact a harbinger of technical problems on a practical level, since the dilutions must be able to take place in environments that are not necessarily equipped, and must be able to be carried out quickly and in an optimal way.

In fact, it cannot be excluded that a barman needs to prepare a flavored syrup while he is working at the counter in the presence of customers, to meet requests not foreseen in advance, therefore having to operate with maximum speed and in conditions of absolute practicality.

After all, the main purpose of the invention is precisely to satisfy every creative need, in terms of flavors, even contingent needs that can emerge at any time, with the utmost flexibility.

The second fundamental ingredient is the aromatic essence indicated with the number 120 which, in a preferred embodiment, is supplied to the barman in a vial, possibly equipped with a suitable dropper, or in any case equipped with a nozzle suitable for regulating the delivery with high precision.

Having the foresight to use a bottle a little larger than the amount of “basic syrup” 110 provided, the bottle itself (without the need to pour its contents into another container) can be used to shake its content more or less vigorously, after a small amount of aromatic essence has been poured into it, thus obtaining a flavored and well-mixed syrup.

In this regard, it is highlighted the importance of providing a packaged product in such a way as to facilitate mixing by shaking, as this method is very effective for obtaining rapid and well-homogeneous mixing, even in the presence of a fairly viscous diluting fluid such as the “basic syrup” according to the invention.

Therefore, the first phase of the preparation process of the “auteur drink” 100 consists in the flavoring of the syrup which takes place by pouring a small amount of aromatic essence 120 into the “basic syrup” 110. This operation is indicated in FIG. 1 with the number 210, and allows the barman both to choose which aroma to use and to dose the quantity, so as to be able to very finely adjust the intensity and aromatic quality to be given to the drink 100.

It should be noted that this possibility of choice offers a great degree of freedom to the barman, who could also use a combination of two or more aromatic essences, considerably expanding his possibility of researching new flavors.

The second phase of the process consists in the mechanical mixing of the “basic syrup” 110 with the aromatic essence 120, or with the aromatic essences, if the barman has chosen to use more than one.

As mentioned, mechanical mixing by shaking is the preferred technique and it is also facilitated, supplying the “basic syrup” 110 directly in a bottle that can be used as a “shaker”.

This very convenient option of using a supply bottle of the “basic syrup” 110 which can also be used as a “shaker”, requires that this bottle has at least two characteristics that make it suitable for this function:
i. it must be larger than the quantity of “basic syrup” 110 that is supplied, for example a 750 ml bottle can be conveniently used to supply 500 ml of “basic syrup” 110, and
ii. it must have a convenient opening to introduce the aromatic essence 120, accompanied by a resealable cap with good seal.

The cap, in some embodiments, can integrate an element that extends deeply towards the inside of the bottle, this element can have the shape of a whip or be a sort of ladle and, when the cap closes the bottle, this element is well immersed in the contained fluid, so that when the bottle is shaken to act as a “shaker”, the fluid moves enough thanks also to the fact that the capacity of the bottle is abundant, and this internal element helps to make quickly homogeneous the mixing of the “basic syrup” 110 with the aromatic essence 120.

At this point, the barman has an absolutely personalized flavored syrup, obtained with very simple and practical mechanical mixing procedures, which can be operated in any bar or kiosk, and he can use this personalized syrup to make any “auteur drink” he has in mind.

The last stage of preparation is indicated with the number 230 and it is not detailed, as it does not concern the object of the present invention. In the final phase 230 the barman draws on other ingredients, indicated with the number 199 and prepares his “auteur drink” 100 with techniques and recipes referable to the known art, or with other more or less original techniques and recipes, but however, which are not object of the present invention.

The invention, in fact, specifically concerns the use of the flavored syrup obtained using a new ingredient, consisting of the “basic syrup” 110, and through the original use of aromatic essences 120.

### Embodiments and Concluding Remarks

In summary, the teachings of the present invention allow to satisfy the purposes for which it was conceived by exploiting in an unprecedented way a shrewdness of a technical nature. In other words, it is indicated how to prepare a flavored syrup in a very flexible and practical way, being its preparation possible, substantially, at the time of need. All this, starting from a universal ingredient called “basic syrup”, which only bears the sweet taste, and is suitable for mixing in a simple and fast way with another type of ingredient, not widespread today in the world of preparations of the so-called “auteur drinks”, that is the aromatic essences used in concentrated form, or as available according to traditional techniques.

Assuming the use of these two characterizing ingredients, which must be considered essential, the invention can be implemented with numerous variations: above all, due to the fact that a freely flavored syrup, according to the teachings of the invention, can be used in a substantially indefinable multitude of different combinations of ingredients, with different dosages and different preparation methods.

Some variants of particular interest concern the so-called aromatic essences. In fact, as already noted, these are substances for which there is a long tradition, as well as a great variety of techniques for their extraction. It is therefore legitimate to assume that the very concept of “aromatic essence” can evolve in its meaning, including all those extremely concentrated aromatic substances that condense all the aromatic potential that can be obtained from a natural substance into minimal, absolutely restricted quantities. Therefore, it cannot be ruled out that over time new substances will become available, extracted using methods that are also of a new conception.

In the meaning of this invention, therefore, the expression “aromatic essence” must include any dilutable substance, even of a new or future conception, which condenses a particular aroma with maximum concentration. In fact, having such a substance it is certainly possible to implement the process of preparing an “auteur drink” according to the invention.

Other variations may concern the container with which the so-called “basic syrup” is supplied to the barman. In principle, each bartender could use their own containers to perform the mixes, and the “basic syrup” could be supplied in simple bottles with no special requirements. However, as highlighted in the previous description, it is undoubtedly very practical to be able to supply the “basic syrup” directly in containers that can be used for the subsequent flavoring with any aromatic essence. Obviously, in the case of this choice, different types of containers can be designed giving rise to numerous implementation variants: the only essential characteristics concern the capacity, which must be greater than the nominal quantity of “basic syrup” supplied with the container itself; and the cap, which must be resealable and must allow to easily create a seal sufficient to support the shaking of the contents without the risk of leaks.

Therefore, especially in the context of evolutionary scenarios, the invention lends itself to incorporating and supporting further development and refinement efforts, capable of improving, or increasing, the performance of the invention as described in the light of current scenarios. Further developments could therefore be made by man skilled in the art without thereby departing from the scope of the invention, as it results from this description and the attached claims, which form an integral part of the description itself; or, if said developments are not included in the present description, they may be the subject matter of further patent applications associated with the present invention, or dependent on it.

1. A basic syrup (110), suitable for use as a base for making a plurality of flavored syrups, comprising the following ingredients:
i. in a preponderant quantity, altogether greater than 90%, water and extracts of one or more sweetening plants,
ii. in a smaller quantity, a juice of one or more fruits that give acidity, iii. and little quantities, not exceeding 0.3%, of preservative substances; and said basic syrup (110) is characterized in that:
a. it does not include any further flavoring ingredient,
b. the concentration of said extracts of sweetening plant in water is at least 63 brix,
c. said extracts of sweetening plant are selected so as to obtain a viscosity lower than 450 cP (centipoise),
d. said basic syrup (110) is suitable to act as diluting substance for aromatic essences and,
e. after said basic syrup (110) has been flavored with said aromatic essences, it is suitable for being diluted in a beverage to be prepared.

2. The basic syrup (110) according to claim 1, wherein said juice of one or more fruits which give acidity is lemon juice.

3. The basic syrup (110) according to claim 1 wherein agave juice is included in said extracts of one or more sweetening plants.

4. The basic syrup (110) according to claim 3, wherein cane sugar is also included in said extracts of one or more sweetening plants.

5. The basic syrup (110) according to claim 1 supplied in a package for its delivery, which comprises a bottle equipped with a re-closable cap suitable to hermetically re-close said bottle; and said bottle is designed to act as a shaker, being its capacity larger than the quantity of basic syrup (110) contained, so as said contained basic syrup can be shaken without being poured into another shaking tool.

6. The basic syrup (110) according to claim 5, in which said re-closable cap integrates an element which extends deeply towards the inside of the bottle so that, when said cap closes the bottle, such element is well immersed in the fluid contained.

7. A method for using said basic syrup (110) according to claim 1, for the preparation an auteur drink, being said method suitable for preparing a plurality of beverages with different flavors, and this method involves at least the following steps:
a. diluting of at least one aromatic essence, extracted from natural ingredients, in said basic syrup (110) according to claim 1, thus obtaining a flavored syrup,
b. diluting of said flavored syrup in other ingredients, according to any of the recipes for the preparation of beverages that use syrups.

8. The method according to claim 7 wherein said diluting of said at least one aromatic essence in said basic syrup (110) is made homogeneous by mixing said flavored syrup by shaking it inside a suitably shaped container.

9. The method according to claim 8 wherein said basic syrup (110) is packaged according to claim 5, and said mixing by shaking of said flavored syrup takes place inside said bottle on which said basic syrup (110) is packaged for delivery.
